(19) United States
(12) Patent Application Publication
(10) Pub. No.: US 2004/0009883 A1
(43) Pub. Date: Jan. 15, 2004

(54) Resist stripping composition

(76) Inventors: Kazuto Ikemoto, Tokyo (JP); Kojiro Abe, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/601,624

(22) Filed: Jun. 24, 2003

(30) Foreign Application Priority Data
Jun. 25, 2002 (JP) 2002-184941

(51) Int. Cl. C11D 1/00

(52) U.S. Cl. 510/175; 510/176

(57) ABSTRACT

The resist stripping composition of the present invention comprises 0.001 to 0.5% by weight of a fluorine compound, a mixed solvent of an amide solvent and an ether solvent and water. The resist stripping composition completely removes the resist residues remaining after the dry etching and the ashing in the wiring process for manufacturing semiconductor devices and liquid crystal panel devices comprising IC or LSI in a short period of time with a minimized corrosion of a low dielectric film.

### BACKGROUND OF THE INVENTION

1. Field of the Invention

The present invention relates to a resist stripping composition for use in the production of semiconductor devices and liquid crystal devices.

2. Description of the Prior Art

Semiconductor devices and liquid crystal panel devices comprising IC or LSI have been produced by following the steps of coating a photoresist on an inorganic substrate; patterning the photoresist by exposure to light and development; dry-etching the non-masked area of an electrically conductive film deposited on the inorganic substrate by a reactive gas using the patterned photoresist as a mask; ashing the photoresist; and removing the remaining resist residue (build-up residue) from the inorganic substrate.

The electrically conductive film on the inorganic substrate is generally dry-etched by a chlorine-containing reactive gas, which reacts with the photoresist to leave a resist residue. Since the remaining build-up residue causes various troubles such as open circuit and defective wiring, the resist residue should be completely removed.

Conventionally, the resist residue has been generally removed by an alkaline stripping composition such as a stripping composition comprising an ethylene oxide adduct of an alkanol amine or polyalkylene-polyamine, a sulfone compound and a glycol monoalkyl ether (Japanese Patent Application Laid-Open No. 62-49355) and a stripping composition comprising dimethyl sulfoxide as a main ingredient, a diethylene glycol monoalkyl ether and a nitrogen-containing organic hydroxy compound (Japanese Patent Application Laid-Open No. 64-42653). These alkaline stripping compositions show a strong alkaline nature by liberating amine upon absorbing moisture during the use, or show a strong alkaline nature if water is used in place of an organic solvent such as alcohol in the washing process after removing the resist residue. Therefore, the proposed stripping compositions are extremely corrosive to aluminum, etc. that are widely used as the material for fine circuit wiring, failing to meet the recent requirement to severe dimension precision in fine processing.

Recently, aqueous solutions containing a fluorine compound, an amide, dimethylsulfoxide and a corrosion inhibitor have come to be used as the resist stripping composition because of their high removal ability of resist residue and easiness of using (Japanese Patent Application Laid-Open Nos. 8-202052 and 11-067632). However, the proposed resist stripping compositions are strongly corrosive to low dielectric films made of so-called low-k materials such as tetraethylorthosilicate (TEOS), hydrogen silsesquioxane (HSQ) and SiOF (FSG).

### SUMMARY OF THE INVENTION

An object of the present invention is to provide a resist stripping composition capable of completely removing the resist residue remaining after dry etching or ashing in the wiring process for semiconductor devices or liquid crystal devices comprising IC or LSI at low temperatures in a short period of time with a minimized corrosion of low dielectric films.

As a result of extensive study in view of solving the problems in the prior art, the inventors have found that the removal of the resist residue remaining after the dry-etching process using a reactive gas or after the ashing process is significantly facilitated without the corrosion of wiring materials by the use of a resist stripping composition comprising an aqueous solution containing 0.001 to 0.5% by weight of a fluorine compound and a mixed solvent of an amide solvent and an ether solvent. The inventors have further found that such a resist stripping composition does not corrode the wiring also in a rinsing operation. The present invention has been accomplished on the basis of these findings.

Thus, the present invention provides a resist stripping composition comprising 0.5% by weight or less of a fluorine compound, an amide/ether mixed solvent and water.

### DETAILED DESCRIPTION OF THE INVENTION

The fluorine compound used in the present invention includes hydrogen fluoride and fluorides of ammonium, organic amine and quaternary organic ammonium. Examples thereof include ammonium fluoride, hydrogen fluoride, acid ammonium fluoride, methylamine hydrogen fluoride, ethylamine hydrogen fluoride, propylamine hydrogen fluoride, tetramethylammonium fluoride, tetraethylammonium fluoride, ethanolamine hydrogen fluoride, methylethanolamine hydrogen fluoride, dimethylethanolamine hydrogen fluoride, hydroxylamine hydrogen fluoride, dimethylhydroxylamine hydrogen fluoride, and triethylenediamine hydrogen fluoride, with ammonium fluoride and tetramethylammonium fluoride being preferred and ammonium fluoride being more preferred. These fluorine compounds may be used alone or in combination. The content of the fluorine compound is 0.001 to 0.5% by weight of the resist stripping composition. If exceeding 0.5% by weight, the fluorine compound unfavorably precipitates.

The amide solvent has a dielectric constant of 25 or more. Although high in the resist stripping ability because of its high dielectric constant, the amide solvent is highly corrosive to low-k materials and has a low solubility to the fluorine compounds. As compared with the amide solvent, the ether solvent is somewhat inferior in the resist stripping ability, but high in the solubility to the fluorine compounds and less corrosive to low-k materials. In the present invention, only the beneficial effects of the amide solvent and the ether solvent are utilized by the combined use thereof. The content of each of the amide solvent and the ether solvent is preferably 5 to 90% by weight, more preferably 5 to 85% by weight of the resist stripping composition. The mixing ratio, amide solvent:ether solvent, may be suitably selected according to the chemical properties of the resist to be removed, the stripping conditions, etc. and preferably 100:1 to 1:100, more preferably 100:5 to 5:100 by weight. If deviating far from the above range, i.e., one is used in excess of the other, the effect of mixing cannot be attained.

Examples of the amide solvents include formamide, N-methylformamide, N,N-dimethylformamide (DMF), acetamide, N-methylacetamide, N,N-dimethylacetamide (DMAC), N,N-dimethylpropanamide, lactamide, hydroxybutyramide, dimethyl sulfoxide (DMSO), sulfolane, hexamethyl phosphoramide (HMPA), pyrrolidone, N-methylpyrrolidone (NMP), tetramethylurea, N,N′-dimethylethyleneurea, N,N′-dimethylpropyleneurea, methyl dimethylcarbamate, and acetonitrile.

Preferred amide solvents are represented by the following formula 1:

R¹CONR²R³ (1)

wherein R¹, R² and R³ are each independently hydrogen, alkyl group or hydroxyalkyl group.

The alkyl group is preferably a straight-chain or branched alkyl having 1 to 5 carbon atoms, such as methyl group, ethyl group, propyl group, butyl group and pentyl group. The hydroxyalkyl group is preferably a straight-chain or branched hydroxyalkyl having 1 to 5 carbon atoms, such as hydroxymethyl group, hydroxyethyl group and hydroxypropyl group.

Examples of the ether solvents include methyl cellosolve, ethyl cellosolve, butyl cellosolve, dimethoxyethylene, diethylene glycol monomethyl ether, diethylene glycol monobutyl ether, diethylene glycol monoethyl ether, diethylene glycol dimethyl ether, triethylene glycol monomethyl ether, triethylene glycol monobutyl ether, polyethylene glycol monomethyl ether, methoxybutanol, methoxymethylbutanol, dioxane, dioxolane, trioxane, tetrahydrofuran (THF), crown ether, propylene glycol monomethyl ether, dipropylene glycol monomethyl ether, tripropylene glycol monomethyl ether, propylene glycol monobutyl ether, dipropylene glycol monobutyl ether, tripropylene glycol monobutyl ether, polyethylene glycol and polypropylene glycol.

Preferred ether solvents are represented by the following formula 2:

R⁴OR⁵ (2)

wherein R⁴ and R⁵ are each independently alkyl group, alkoxyalkyl group, hydroxyalkyl group or hydroxyalkoxyalkyl group.

The alkyl or alkoxyalkyl group is preferably a straight-chain or branched alkyl having 1 to 10 carbon atoms, such as methyl group, ethyl group, propyl group, butyl group, methoxyethyl group, butoxyethyl group, methoxypropyl group and propoxypropyl group. The hydroxyalkyl or hydroxyalkoxylalkyl group is preferably a straight-chain or branched hydroxyalkyl having 1 to 10 carbon atoms, such as hydroxyethyl group, hydroxyethoxyethyl group, hydroxypropyl group and hydroxypropoxypropyl group. with ω-hydroxyalkyl group being more preferred. Preferred are glycol ethers because of their easy availability and easiness to handle.

These amide solvents and ether solvents may be respectively used alone or in combination of two or more.

The content of the amide/ether mixed solvent is 1 to 99.99% by weight, preferably 30 to 98% by weight, more preferably 82 to 95% by weight of the resist stripping composition. If the content is less than 30% by weight, the corrosion of the wiring materials becomes severe.

The content of water is determined depending on the contents of the fluorine compound and the amide/ether mixed solvent, and preferably 0.1 to 70% by weight of the resist stripping composition.

The resist stripping composition of the present invention is used to remove the resist residue remaining on the inorganic substrate after the dry etching by a reactive gas and the subsequent ashing with a plasma. The stripping operation is sufficiently performed at room temperature, but may be performed at elevated temperatures, if desired. After the stripping operation, the inorganic substrate is rinsed with a rinsing liquid, for example, super pure water or a water-soluble organic solvent such as methyl alcohol, ethyl alcohol, isopropanol, dimethylacetamide, dimethyl sulfoxide, glycol ether and ethanolamine. The rinsing liquid may be a mixture of super pure water and the water-soluble organic solvent.

The resist stripping composition of the present invention may contain a cationic, anionic or nonionic surfactant and an alkaline compound such as amines, ammonia, ammonium salts and hydroxyl amines. A chelating compound of phosphorus acid type, carboxylic acid type, amine type or oxime type may be contained in the resist stripping composition. Other compounds that are optionally contained include carboxylic compounds and their organic salts such as formic acid, acetic acid, propionic acid, butyric acid, isobutyric acid, oxalic acid, malonic acid, succinic acid, glutaric acid, maleic acid, fumaric acid, benzoic acid, phthalic acid, 1,2,3-benzenetricarboxylic acid, glycolic acid, lactic acid, malic acid, citric acid, acetic anhydride, phthalic anhydride, maleic anhydride, succinic anhydride, salicylic acid, and organic salts of the preceding carboxylic compounds. These compounds may be used alone or in combination of two or more. The resist stripping composition of the present invention may further contain a sugar, a sugar alcohol, a polyphenol and a quaternary ammonium salt as a corrosion inhibitor for the inorganic substrate.

The inorganic substrate to be treated in the present invention may be made of various materials such as silicon, amorphous silicon, polysilicon and glass. Generally, the inorganic substrate has on its surface thin films made of semiconductor wiring materials such as silicon oxide, silicon nitride, aluminum, aluminum alloy, titanium, titanium-tungsten, titanium nitride, tungsten, tantalum, tantalum oxide, tantalum alloy, chromium, chromium oxide, chromium alloy and indium-tin-oxide (ITO); and compound semiconductors such as gallium-arsenic, gallium-phosphorus and indium-phosphorus.

The present invention will be explained in more detail by reference to the following example which should not be construed to limit the scope of the present invention.

### EXAMPLE 1

A thin oxide film and a thin Al alloy (Al—Si—Cu) film were successively deposited on a silicon substrate. A photoresist applied on the thin Al alloy film was patterned. Then, the thin Al alloy film was dry-etched using the patterned photoresist as the mask to form Al alloy wiring, followed by ashing in an oxygen plasma to prepare a semiconductor device test piece. The resist residues remained on the side walls of the Al alloy wiring.

The test piece was immersed in a resist stripping composition comprising 50% by weight of diethylene glycol monomethyl ether, 35% by weight of dimethylacetamide, 0.1% by weight of ammonium fluoride and a balance of water at room temperature for 10 min. After the immersion, the test piece was rinsed with ultra pure water and dried. The removal of the remaining resist residues on the side walls and the corrosion of the surface of the Al alloy wiring were examined under an electron microscope (SEM). The resist residues were completely removed and no corrosion was noticed on the Al alloy wiring.

The etching rate of tetraethylorthosilicate (TEOS) film for evaluating the corrosion tendency to a low dielectric film was 1 Å/min or less.

### EXAMPLES 2-21

The same tests as in Example 1 were repeated on various resist stripping compositions having different formulations. The results are shown in Table 1.

TABLE 1

| | | | | | Fluorine | | | |
|---|---|---|---|---|---|---|---|---|
| | Amide solvents | | Ether solvents | | compounds | | | Water |
| Examples | kind | wt % | kind | wt % | kind | wt % | Additives | wt % |
| 2 | DMAC | 70 | MDG | 15 | NH₄F | 0.1 | — | 14.9 |
| 3 | DMAC | 70 | MTG | 15 | NH₄F | 0.1 | — | 14.9 |
| 4 | DMAC | 90 | PEG | 5 | NH₄F | 0.1 | — | 4.9 |
| 5 | DMF | 70 | MDG | 15 | NH₄F | 0.1 | — | 14.9 |
| 6 | DEAC | 35 | MDG | 50 | NH₄F | 0.1 | — | 14.9 |
| 7 | DMAC | 20 | MDG | 60 | NH₄F | 0.2 | — | 19.8 |
| 8 | DMF | 20 | MDG | 60 | NH₄F | 0.2 | — | 19.8 |
| 9 | MMAC | 20 | MDG | 50 | NH₄F | 1 | — | 29 |
| 10 | DMAC | 35 | BDG | 50 | NH₄F | 0.02 | — | 14.98 |
| 11 | DMAC | 66 | MDG | 15 | NH₄F | 0.1 | CH₃COONH₄ | 14.9 |
| | | | | | | | 4 wt % | |
| 12 | DMAC | 69 | MDG | 15 | NH₄F | 0.1 | NH₃ | 14.9 |
| | | | | | | | 1 wt % | |
| 13 | DMAC | 66 | MDG | 15 | NH₄F | 0.1 | butanone | 14.9 |
| | | | | | | | oxime | |
| | | | | | | | 4 wt % | |
| 14 | DMAC | 10 | DMDG | 75 | NH₄F | 0.02 | | 14.98 |
| 15 | DMAC | 70 | MDG | 15 | NH₄F | 0.1 | EA | 14.898 |
| | | | | | | | 0.002 wt % | |
| 16 | DMAC | 10 | MDG | 85 | EA-HF | 0.02 | — | 4.98 |
| 17 | DMAC | 70 | MPG | 15 | NH₄F | 0.02 | — | 14.98 |
| 18 | DMSO | 70 | MDG | 15 | NH₄F | 0.2 | — | 14.8 |
| 19 | DMAC | 70 | MDP | 15 | NH₄F | 0.1 | — | 14.9 |
| 20 | DMAC | 20 | MDG | 65 | NH₄F | 0.2 | — | 14.8 |
| 21 | DMF | 20 | MDG | 50 | NH₄F | 1 | — | 29 |

Amide Solvents

DMAC: Dimethylacetamide

DMF: Dimethylformamide

DEAC: Diethylacetamide

MMAC: Monomethylacetamide

DMSO: Dimethyl sulfoxide

Ether Solvents

MDG: Diethylene glycol monomethyl ether

MTG: Triethylene glycol monomethyl ether

PEG: Polyethylene glycol

BDG: Diethylene glycol monobutyl ether

DMDG: Diethylene glycol dimethyl ether

MPG: Propylene glycol monomethyl ether

MDP: Dipropylene glycol monomethyl ether

Flourine Compounds

EA-HF: Ethanolamine hydrogen fluoride

Additives

EA: Ethanolamine

TABLE 1
(Contd.)

| | | | TOES Etching Rate |
|---|---|---|---|
| Examples | Resist Residues | Al Corrosion | (Å/min) |
| 2 | removed | none | <1 |
| 3 | removed | none | <1 |
| 4 | removed | none | <1 |
| 5 | removed | none | <1 |
| 6 | removed | none | <1 |
| 7 | removed | none | 1 |
| 8 | removed | none | 1.5 |
| 9 | removed | none | 1.8 |
| 10 | removed | none | <1 |
| 11 | removed | none | 1 |
| 12 | removed | none | 1 |
| 13 | removed | none | <1 |
| 14 | removed | none | <1 |
| 15 | removed | none | <1 |
| 16 | removed | none | <1 |
| 17 | removed | none | <1 |
| 18 | removed | none | <1 |
| 19 | removed | none | <1 |
| 20 | removed | none | 1.5 |
| 21 | removed | none | 1.9 |

### COMPARATIVE EXAMPLE 1

A test piece was immersed in a solution comprising 85% by weight of diethylene glycol monomethyl ether, 0.1% by weight of ammonium fluoride and a balance of water at room temperature for 10 min. After the immersion, the test piece was rinsed with ultra pure water and dried. The removal of the remaining resist residues on the side walls and the corrosion of the surface of the Al alloy wiring were examined under an electron microscope (SEM). The resist residues were not removed.

### COMPARATIVE EXAMPLE 2

The attempt to prepare a solution comprising 85% by weight of dimethylacetamide, 0.2% by weight of ammonium fluoride and a balance of water failed because of the precipitation of ammonium fluoride.

### COMPARATIVE EXAMPLE 3

A solution comprising 69% by weight of dimethylformamide, 1% by weight of ammonium fluoride and a balance of water was evaluated in the same manner as in Example 1. Although the resist residues were removed, the TEOS etching rate was 7 Å/min to show a high corrosion tendency to a low dielectric film.

As described above, the resist stripping composition of the present invention easily removes the resist residues remaining after the dry etching with a reactive gas and after the ashing with a minimized corrosion of a low dielectric film.

What is claimed is:

1. A resist stripping composition comprising 0.001 to 0.5% by weight of a fluorine compound, a mixed solvent of an amide solvent and an ether solvent and water.

2. The resist stripping composition according to claim 1, wherein the fluorine compound is a fluoride of ammonium, amine or quaternary organic ammonium.

3. The resist stripping composition according to claim 1, wherein the ether solvent is a glycol ether.

4. The resist stripping composition according to claim 1, wherein the amide solvent has a dielectric constant of 25 or more.

5. The resist stripping composition according to claim 1, wherein the fluorine compound is selected from the group consisting of hydrogen fluoride, ammonium fluoride, acid ammonium fluoride, methylamine hydrogen fluoride, ethylamine hydrogen fluoride, propylamine hydrogen fluoride, tetramethylammonium fluoride, tetraethylammonium fluoride, ethanolamine hydrogen fluoride, methylethanolamine hydrogen fluoride, dimethylethanolamine hydrogen fluoride, hydroxylamine hydrogen fluoride, dimethylhydroxylamine hydrogen fluoride, and triethylenediamine hydrogen fluoride.

6. The resist stripping composition according to claim 1, wherein the fluorine compound is ammonium fluoride.

7. The resist stripping composition according to claim 1, further comprising a corrosion inhibitor.

8. The resist stripping composition according to claim 6, wherein the corrosion inhibitor is at least one compound selected from the group consisting of aromatic hydroxy compounds, carboxylic compounds, organic salts of the carboxylic compounds and chelating compounds.

9. The resist stripping composition according to claim 1, wherein the amide solvent is at least one compound selected from the group consisting of formamide, N-methylformamide, N,N-dimethylformamide, acetamide, N-methylacetamide, N,N-dimethylacetamide, N,N-dimethylpropanamide, lactamide, hydroxybutyramide, dimethyl sulfoxide, sulfolane, hexamethyl phosphoramide, pyrrolidone, N-methylpyrrolidone, tetramethylurea, N,N′-dimethylethyleneurea, N,N′-dimethylpropyleneurea, methyl dimethylcarbamate, and acetonitrile.

10. The resist stripping composition according to claim 1, wherein the ether compound is at least one compound selected from the group consisting of methyl cellosolve, ethyl cellosolve, butyl cellosolve, dimethoxyethylene, diethylene glycol monomethyl ether, diethylene glycol monobutyl ether, diethylene glycol monoethyl ether, diethylene glycoldimethyl ether, triethylene glycol monomethyl ether, triethylene glycol monobutyl ether, polyethylene glycol monomethyl ether, methoxybutanol, methoxymethylbutanol, dioxane, dioxolane, trioxane, tetrahydrofuran, crown ether, propylene glycol monomethyl ether, dipropylene glycol monomethyl ether, tripropylene glycol monomethyl ether, propylene glycol monobutyl ether, dipropylene glycol monobutyl ether, tripropylene glycol monobutyl ether, polyethylene glycol and polypropylene glycol.

11. The resist stripping composition according to claim 1, wherein the amide compound is represented by the following formula 1:
R¹CONR²R³ (1)
wherein R¹, R² and R³ are each independently hydrogen, alkyl group or hydroxyalkyl group.

12. The resist stripping composition according to claim 1, wherein the ether compound is represented by the following formula 2:
R⁴OR⁵ (2)
wherein R⁴ and R⁵ are each independently alkyl group, alkoxyalkyl group, hydroxyalkyl group or hydroxyalkoxyalkyl group.

13. The resist stripping composition according to claim 1, wherein the content of the amide solvent is 0.5% by weight or more and the content of the ether solvent is 0.5% by weight or more, each based on a total weight of the resist stripping composition.

14. The resist stripping composition according to claim 1, wherein the content of the amide solvent is 0.5% by weight or more, the content of the ether solvent is 0.5% by weight or more, and the content of the mixed solvent is 30% by weight or more, each based on the total weight of the resist stripping composition.
